(19) United States
(12) Patent Application Publication
(10) Pub. No.: US 2005/0273237 A1
(43) Pub. Date: Dec. 8, 2005

(54) Control method and control structure for lighting system

(76) Inventors: Jyh-Haur Huang, Sinyuan Township (TW); Chih-Kuang Chen, Kaohsiung City (TW)

Correspondence Address: David I. Roche;BAKER & McKENZIE, 130 E. Randolph Drive, Chicago, IL, 60601, US

(21) Appl. No.: 10/850,726

(22) Filed: May 21, 2004

(51) Int. Cl. G06F 7/00

(52) U.S. Cl. 701/49

(57) ABSTRACT

A lighting system comprises a plurality of light-emitting devices of different color emissions, a plurality of current drivers delivering electric currents to the light-emitting devices in response to drive signals, and a control circuit operable to configure the drive signals in response to a difference between the light outputs from the light-emitting devices and preset light intensity references. In a control method, the drive signals are configured to adjust the respective light outputs of specific colors to the light intensity references. The color temperature of the lighting system can be thereby kept constant.

### BACKGROUND OF THE INVENTION

1. Field of the Invention

This invention relates to the field of electroluminescent devices, and more particularly to a control scheme implemented in a lighting system to control the light outputs at a color temperature.

2. Description of the Related Art

The rapid progress made in the field of display technology has particularly driven the development of electroluminescent devices, also commonly called light-emitting devices (LEDs). LEDs can be implemented in a wide range of applications including backlight modules of liquid crystal displays, direct light sources of display in electroluminescent displays, lighting systems, etc.

In operation, a forward electric current flows through the LED to produce light. Depending on the specific active material incorporated therein, the LED can be configured to irradiate light of a particular color. The color emission is usually determined according to the requirement of the particular application of the LED.

U.S. Pat. No. 6,411,046, which is incorporated herein by reference, describes a lighting system that incorporates LEDs of different color emissions additively mixing with one another to produce white light. To prevent undesirable chromatic deviation of the white light, this patent reference discloses a control method that incorporates LED chromaticity coordinates and LED temperature as factor of adjustment of the LED light outputs. Such a control scheme is accomplished by automatic regulation and requires the implementation of a complex structure, including micro-controllers to compute the control rules, to be effective.

Therefore, there is presently a need for a control structure and control method that can simplify the manufacture of the lighting system and reduce the manufacture cost.

### SUMMARY OF THE INVENTION

The application describes a lighting system and a method of controlling the operation of a lighting system that can overcome the prior problems.

In one embodiment, the lighting system comprises a plurality of light-emitting devices of different color emissions, a plurality of current drivers delivering electric currents to the light-emitting devices in response to drive signals, and a control circuit operable to configure the drive signals in response to a difference between the light outputs from the light-emitting devices and preset light intensity references.

In another embodiment, the method of controlling the lighting system includes generating electric currents flowing through the light-emitting devices to produce light outputs of different colors, wherein the level of the electric currents respectively varies in response to a plurality drive signals, and configuring the drive signals in response to a difference between the light outputs from the light-emitting devices and preset light intensity references.

In an embodiment, one light intensity reference reflects a target average of light output for one color emission. In a variant embodiment, configuring the drive signals further includes configuring the drive signals to adjust the respective light outputs of specific color emissions to the light intensity references. In a variation, the drive signals include pulse width modulated signals the duty cycles of which are set according to the difference between the light intensity references and the light outputs of specific colors.

The foregoing is a summary and shall not be construed to limit the scope of the claims. The operations and structures disclosed herein may be implemented in a number of ways, and such changes and modifications may be made without departing from this invention and its broader aspects. Other aspects, inventive features, and advantages of the invention, as defined solely by the claims, are described in the non-limiting detailed description set forth below.

### BRIEF DESCRIPTION OF THE DRAWINGS

FIG. 1A is a schematic view of a lighting system according to an embodiment of the invention; and

FIG. 1B is a flowchart of a method of controlling the operation of a lighting system according to an embodiment of the invention

### DETAILED DESCRIPTION OF THE EMBODIMENT(S)

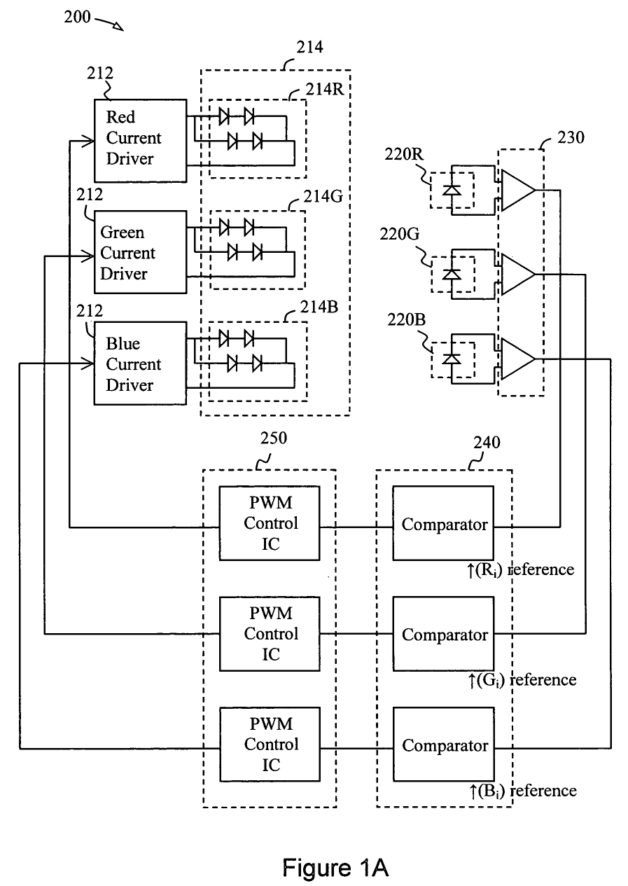

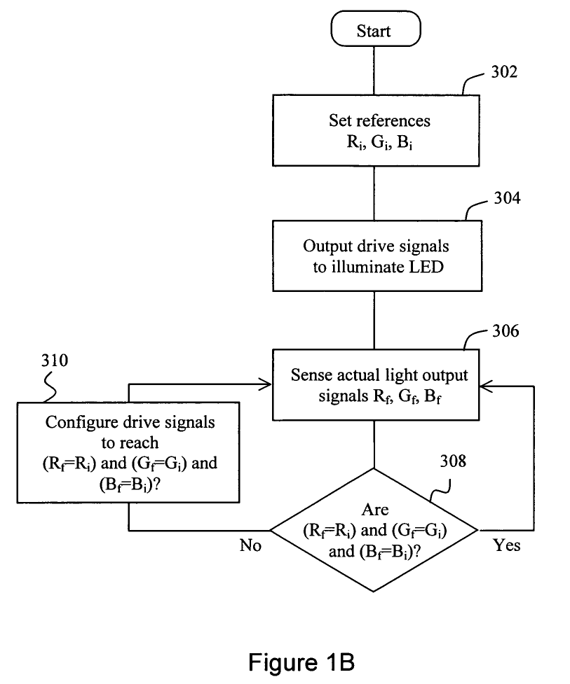

FIG. 1A is a block diagram illustrating the general structure of a lighting system according to an embodiment of the invention. The lighting system 200 includes arrays of LEDs collectively designated as reference numeral 214. In the example illustrated herein, the LEDs 214 include LEDs of different color emissions 214R, 214G, 214B, configured to irradiate red, green, and blue light, respectively. The LEDs 214 can include organic LED, semiconductor LED or the like.

Current drivers 212 are operable to generate electric currents flowing through the LEDs 214R, 214G, 214B. Upon the input of current levels from the current drivers 212, the LEDs 214R, 214G, 214B irradiate diverse light outputs of basic light colors R, G, B that mix with one another to achieve a full spectrum of colors.

Color photosensors 220 are installed to determine the brightness of specific colors emitted by the LEDs 214R, 214G, 214B, respectively. Red color photosensor 220R is configured to sense the brightness of red color irradiated from the red LEDs 214R, green color photosensor 220G is configured to sense the brightness of green color irradiated from the green LEDs 214G, and blue color photosensor 220B is configured to sense the brightness of blue color irradiated from the blue LEDs 214B. The photosensors 220 can be photodiodes equipped with color filters configured selectively pass red, green and blue lights, respectively.

The analog signals issued from the color photosensors 220 according to the amount of light sensed for each color R, G, B are scaled via amplifiers 230 before they are inputted to comparators 240. The comparators 240 output feedback signals reflecting the differences between the sensed color outputs R, G, B and references Rᵢ, Gᵢ, Bᵢ, which characterize the error between the target light outputs and the actual light outputs of red, green and blue, respectively.

In response to the feedback signals, controllers 250 deliver respective drive signals to the current drivers 212 to control and adjust the level of electric current supplied to the LEDs 214. In an embodiment, the controllers 250 can be implemented as pulse width modulated (PWM) control integrated circuits. In PWM control, the drive signals are configured in the form of PWM duty cycles delivered to the current drivers 212 to adjust the LED driving electric current.

It understood that the foregoing PWM control implementation is only an example provided for the purpose of illustration, and other variant control schemes such as amplitude modulated control or the like can be also suitable.

FIG. 1B is a flowchart of exemplary steps performed in a method of driving a lighting system according to an embodiment of the invention. For purposes of illustration, various steps are described in particular order in the present example. However, when supported by accompanying hardware and software, these steps can be performed according to different sequences.

Initially, reference values Rᵢ, Gᵢ, Bᵢ are set in accordance with the desired intensity of the light outputs R, G, B from LEDs of different colors (302). In an embodiment, the references Rᵢ, Gᵢ, Bᵢ can be set corresponding to target averages of light outputs of red, green and blue color for a desired color temperature. Drive signals are outputted to illuminate the LEDs (304). In an embodiment, the drive signals can be pulse width modulated signals the duty cycles of which determine the levels of light outputs from the LEDs.

The lights of different colors irradiated from the LEDs are sensed (306), and corresponding sensing signals R_{f}, G_{f}, B_{f} are generated and respectively compared with the references Rᵢ, Gᵢ, Bᵢ (308). If one or more of the target references Rᵢ, Gᵢ, Bᵢ is not met the drive signals are accordingly configured to correct the respective light outputs of the LEDs to the levels defined by the references Rᵢ, Gᵢ, Bᵢ (310). The steps 306˜310 form an infinite loop in which the light outputs R_{f}, G_{f}, B_{f} from the LEDs are continuously sensed so as to determine and correct any light output variations relative to the references Rᵢ, Gᵢ, Bᵢ.

The lighting system and control method as described herein can be implemented in a wide range of LED applications, and more particularly in white lighting systems used as backlights of liquid crystal displays. The feedback control scheme allows to simply maintain a constant color temperature of the emitted white light based upon the detection of the LED light outputs.

Realizations in accordance with the present invention have been described in the context of particular embodiments. These embodiments are meant to be illustrative and not limiting. Many variations, modifications, additions, and improvements are possible. Accordingly, plural instances may be provided for components described herein as a single instance. Additionally, structures and functionality presented as discrete components in the exemplary configurations may be implemented as a combined structure or component. These and other variations, modifications, additions, and improvements may fall within the scope of the invention as defined in the claims that follow.

1. A lighting system, comprising:
a plurality of light-emitting devices of different color emissions;
a plurality of current drivers, wherein each current driver is configured to deliver an electric current to one or more light-emitting device of one specific color emission in response to a drive signal; and
a control circuit coupled with the current drivers, wherein the control circuit is operable to configure the drive signals in response to the differences between predetermined light intensity references and the light outputs of different color emissions from the light-emitting devices.

2. The lighting system according to claim 1, further comprising:
a plurality of color photosensors;
a plurality of comparators; and
a plurality of controllers, wherein each controller is configured to output a drive signal in response to a feedback signal from one comparator reflecting a difference between one light intensity reference and one light output of one specific color sensed by a color photosensor.

3. The lighting system according to claim 2, wherein the controllers are configured to output drive signals in the form of pulse width modulated signals.

4. The lighting system according to claim 3, wherein the duty cycle of one pulse width modulated signal is set according to a difference between one light intensity reference and a light output of one specific color.

5. The lighting system according to claim 2, wherein the color photosensors include photodiodes equipped with color filters configured to selectively pass light of specific color ranges.

6. The lighting system according to claim 1, wherein one light intensity reference reflects a target average of light output for one color emission.

7. The lighting system according to claim 1, wherein the drive signals are configured to adjust the respective light outputs of specific colors to the light intensity references.

8. A method of controlling a lighting system including a plurality of light-emitting devices of different color emissions, the method comprising:
sensing the light outputs of different colors from the light-emitting devices and generating corresponding sensed light signals;
generating light intensity reference signals;
comparing the sensed light signals with the light intensity reference signals and generating corresponding feedback signals; and
generating drive signals in response to the feedback signals, wherein the drive signals are configured to adjust the respective light outputs of specific colors to the light intensity references.

9. The method according to claim 8, wherein generating drive signals in response to the feedback signals comprises generating pulse width modulated drive signals including duty cycles varying according to the feedback signals.

10. The method according to claim 8, wherein one light intensity reference signal reflects a target average of light output for one color emission.

11. A method of controlling a lighting system including a plurality of light-emitting devices of different color emissions, the method comprising:
generating electric currents flowing through the light-emitting devices to produce light outputs of different colors, wherein the level of the electric currents respectively varies in response to a plurality drive signals; and
configuring the drive signals in response to the differences between the light outputs of specific colors and preset light intensity references.

12. The method according to claim 11, wherein configuring the drive signals further comprises configuring the drive signals to adjust the respective light outputs of specific colors to the light intensity references.

13. The method according to claim 11, wherein configuring the drive signals further comprises:
sensing the light outputs of different colors from the light-emitting devices and generating corresponding sensed light signals;
comparing the sensed light signals with the light intensity references and generating corresponding feedback signals; and
setting the drive signals according to the feedback signals.

14. The method according to claim 11, wherein the drive signals include pulse width modulated signals.

15. The method according to claim 11, wherein one light intensity reference reflects a target average of light output for one color emission.
